(19) United States
(12) Patent Application Publication
(10) Pub. No.: US 2012/0109375 A1
(43) Pub. Date: May 3, 2012

(54) SOUND LOCALIZING ROBOT

(75) Inventors: John Hallam, Odense SV (DK); Jakob Christensen-Dalsgaard, Odense M (DK)

(73) Assignee: Lizard Technology, Odense M (DK)

(21) Appl. No.: 13/380,991

(22) PCT Filed: Jun. 23, 2010
(86) PCT No.: PCT/DK10/50157

§ 371 Date: Dec. 27, 2011

Related U.S. Application Data
(60) Provisional application No. 61/220,603, filed on Jun. 26, 2009.
(60) Provisional application No. 61/332,821, filed on May 10, 2010.

(51) Int. Cl. G06F 19/00; G01S 3/808

(52) U.S. Cl. 700/245; 367/118

(57) ABSTRACT

There is provided a biomimetic robot modelling the highly directional lizard ear. Since the directionality is very robust, the neural processing is very simple. This mobile sound localizing robot can therefore easily be miniaturized. The invention is based on a simple electric circuit emulating the lizard ear acoustics with sound input from two small microphones. The circuit generates a robust directionality around 2-4 kHz. The output of the circuit is fed to a model nervous system. The nervous system model is bilateral and contains a set of band-pass filters followed by simulated EI-neurons that compare inputs from the two ears. This model is implemented in software on a digital signal processor and controls the left and right-steering motors of the robot. Additionally, the nervous system model contains a neural network that can self-adapt so as to auto-calibrate the device.

### FIELD OF THE INVENTION

The present invention relates to the field of robots equipped with dedicated acoustical sensing systems, i.e. artificial ears. An artificial ear comprises at least a microphone and a sound-guiding element, also referred to as an artificial auricle in the framework of the present invention.

### BACKGROUND OF THE INVENTION

The ears of lizards are highly directional. Lizards are able to detect the direction of a sound source more precisely than most other animals. The directionality is generated by strong acoustical coupling of the eardrums through large mouth cavities enabling sound to reach both sides of the eardrums and cancel or enhance their vibration depending on the phase difference of the sound components. This pressure difference receiver operation of the ear has also been shown to operate in frogs, birds, and crickets, either by a peripheral auditory system or internal neural structures, but lizards are the simplest and most robust example.

Zhang L, et al ((2006) Modelling the lizard auditory periphery; SAB 2006, LNAI 4095, pp. 65-76) teach a lumped-parameter model of the lizard auditory system, convert the model into a set of digital filters implemented on a digital signal processing module carried by a small mobile robot, and evaluate the performance of the robotic model in a phonotaxis task. The complete system shows a strong directional sensitivity for sound frequencies between 1350-1850 Hz and is successful at phonotaxis within this range.

Zhang L, et al ((2008) Modelling asymmetry in the peripheral auditory system of the lizard; Artif Life Robotics 13:5-9) teach a simple lumped-parameter model of the ear followed by binaural comparisons. The paper mentions that such a model has been shown to perform successful phonotaxis in robot implementations, however, the model will produce localization errors in the form of response bias if the ears are asymmetrical. In the paper the authors evaluate how large errors are generated by asymmetry using simulations of the ear model. The study shows that the effect of asymmetry is minimal around the most directional frequency of the ear, but that biases reduce the useful bandwidth of localization.

Christensen-Dalsgaard and Manley ((2008) Acoustical Coupling of Lizard Eardrums; JARO 9: 407-416) teach a lumped-parameter model of the lizard auditory system, and show that the directionality of the lizard ear is caused by the acoustic interaction of the two eardrums. The system is here largely explained by a simple acoustical model based on an electrical analog circuit. Thus, this paper also discloses the underlying principles of the present invention without disclosing the robot architecture and the associated neural network self-calibration feature.

The invention therefore can not be compared with dummy heads having a binaural stereo microphone, where the target is to build a dummy head and the binaural stereo microphone as close as possible as a replica of the human head and ears. Such dummy heads can be used e.g. for dummy head recording by using an artificial model of a human head, built to emulate the sound-transmitting characteristics of a real human head, with two microphone inserts embedded at “eardrum” locations.

It is the object of the present invention to propose a robot equipped with artificial binaural ears.

### SUMMARY OF THE INVENTION

The present invention is directed to a biomimetic robot modelling the highly directional lizard ear.

Specifically the present invention provides a sound directional robot comprising:
two small, omnidirectional microphones or hydrophones, each simulating one eardrum;
digital processing of the microphone signals to emulate the lizard ear acoustics, wherein the output of the circuit is fed to a model nervous system;
said model nervous system is bilateral and contains a set of band-pass filters followed by simulated El-neurons that compare inputs from the two ears by neural subtraction;
a digitally implemented signal processing platform embodying software that controls left and right-steering motors of the robot; and
a nervous system model containing a neural network that can self-adapt so as to auto-calibrate the device.

According to one aspect the invention proposes a robot equipped with a head which comprises actuator means in order to move the head in at least one degree of freedom in order to gaze at the estimated position of a detected sound source. The head is provided with binaural artificial ears (i.e. microphones and pinna-like structures), which respectively comprise an auricle-shaped structure and a microphone. The upper part of the head presents a acoustically dampening surface.

The artificial ears can be functionally connected with computing means inside or outside the head, which computing means are designed for estimating the position of a sound source based on auditory localisation cues, such as e.g. ITD and/or ILD.

A further aspect of the present invention relates to a humanoid robot having a body, two legs, two arms and a head according to any of the preceding claims.

A still further aspect of the invention relates to a method for enhancing auditory localisation cues sensed via binaural artificial ears attached to or integrated into the head of a robot, the method comprising the step of providing at least the upper part of the head with an acoustically dampening surface.

The present invention also provides a sound directional sensor comprising:
two small, omnidirectional microphones or hydrophones, each simulating one eardrum;
an electric circuit emulating the lizard ear acoustics with sound input from the microphones, wherein the output of the circuit is fed to a model nervous system;
said model nervous system is bilateral and contains a set of band-pass filters followed by simulated El-neurons that compare inputs from the two ears by neural subtraction;
a digitally implemented signal processing platform embodying software that generates a directional output; and
a nervous system model containing a neural network that can self-adapt so as to auto-calibrate the sensor.

The present invention further provides a method for enhancing auditory localisation cues sensed via binaural artificial ears attached to or integrated into a robot, the method comprising the step of providing an electric circuit emulating the lizard ear acoustics with sound input from two small microphones, wherein the output of the circuit is fed to a model nervous system, which model nervous system is bilateral and contains a set of band-pass filters followed by simulated El-neurons that compare inputs from the two ears, said model implemented in software on a digital signal processor controlling left and right-steering motors of the robot.

In a particularly preferred embodiment of the present method the nervous system model contains a neural network that can self-adapt so as to auto-calibrate the device.

The robot, sensor, and method of the present invention may be used to locate underwater sound objects and steer robots or pointing devices towards these objects.

The robot, sensor, and method of the present invention may further be used in the localization of the direction and distance of sound objects from a stationary platform/application like for example unattended ground sensors used for perimeter protection of military camps, power plants and other critical infrastructure installations/facilities.

Advantageously the robot, sensor, and method of the present invention may be used for automatic and real-time localization of sound objects in security and surveillance applications/systems like civil and military video surveillance, where the video camera is automatically directed towards an identified sound source, surveillance of private homes, stores and company premises, civil and military reconnaissance from tanks, combat vehicles, naval vessels, air defense guns and wheeled vehicles.

Additionally the robot, sensor, and method of the present invention are suitable in an automatic localization functionality in medico applications like hearing aids and other new handicap aids, and in mobile toys.

### BRIEF DESCRIPTION OF THE DRAWINGS

FIG. 1a shows a schematic diagram of a lizard's ear structure.

FIG. 1b shows a lumped-parameter circuit model of a lizard's ear.

FIG. 2a shows the error when there is only a constant bias ΔR=0.2.

FIG. 2b shows the direction error against frequency f and bias ΔR.

FIG. 3a shows the error when there is only a constant bias ΔL=0.2.

FIG. 3b shows the direction error against frequency f and ΔL.

FIG. 4a shows the direction error when there is only a constant bias ΔCᵣ=−0.2.

FIG. 4b shows the direction error against frequency f and ΔCᵣ.

FIG. 5 shows bandwidth plotted against ΔL and ΔCᵣ.

### DETAILED DESCRIPTION OF THE INVENTION

The ears of lizards are highly directional. Lizards are able to detect the direction of a sound source more precisely than most other animals. The directionality is generated by strong acoustical coupling of the eardrums. A simple lumped-parameter model of the ear followed by binaural comparisons has been shown to perform successful phonotaxis in robot implementations.

However, such a model will produce localization errors in the form of response bias if the ears are asymmetrical. The inventors have evaluated how large errors are generated by asymmetry using simulations of the ear model in Mathematica 5.2. The study shows that the effect of asymmetry is minimal around the most directional frequency of the ear, but that biases reduce the useful bandwidth of localization.

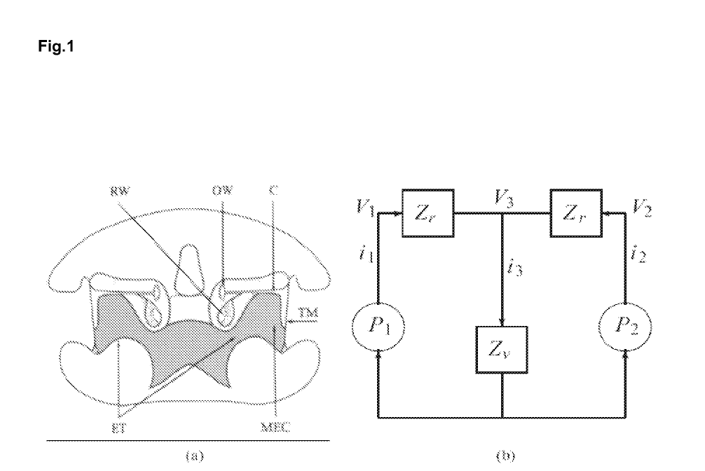

Furthermore, a simple lumped-parameter model of the lizard ear captures most of its directionality, and we have therefore chosen to implement the model in a sound-localizing robot that can perform robust phonotaxis. The model in FIG. 1b has been implemented and tested. It was converted into a set of digital filters and implemented on a DSP StingRay carried by a small mobile robot. Two microphones were used to simulate the ears of the lizard and collect the sound signals. The neural processing of the model is a repeated binaural comparison followed by the simple rule of steering for a short time toward the most excited ear. The robotic model exhibited the behavior predicted from the theoretical analysis: it showed successful and reliable phonotaxis behavior over a frequency range. However, it is obvious that such binaural comparisons are strongly dependent on the ears being symmetrical. In the experiments with the robot, initially the model had a strong bias to one side, which was traced to a difference in the frequency-response characteristics of the two microphones. This difference was corrected by a digital filter to get a useful result.

The invention has been realized in a working system based on a small digital signal processor (StingRay, Tucker-Davis Technologies) and a Lego RCX processor. More recent implementations has been as a Lego NXT brick controlled by an Atmel DIOPSIS DSP board and a Xilinx field programmable gate array. In all cases, the electric circuit, the neural processing and the compensating neural network are implemented in software on the DSP or FPGA. The input to the processor is via two omnidirectional microphones (model FG-23329-P07 from Knowles Electronics, USA) mounted on the front of the robot with a separation of 13 mm.

The invention has also been realized in an underwater sound localizing system, where the sound inputs were two small, omnidirectional hydrophones. To compensate for the four times higher speed of sound in water, the hydrophones were separated by 52 mm. The remaining processing was unchanged. It was shown that the system was able to locate underwater sound.

The performance of the robot has been tested by video tracking the robot and evaluating the localization performance to stationary and moving sound sources. These ongoing studies show that the localization behavior is robust in a frequency band of 500-1000 Hz. Additionally, the robot localization has been simulated in software (Mathematica, Matlab), where different architectures of the neural network has been tested. These simulations clearly show that the self-calibration works and can compensate for any bias due to unmatched microphones.

FIG. 1. a shows a schematic diagram of a lizard's ear structure. TM, tympana membrane; ET, Eustachian tubes; MEC, middle ear cavity; C, cochlea; RW, round window; OW, oval window. b Lumped-parameter circuit model of a lizard's ear. Sound pressures P(1,2) are represented by voltage inputs V(1,2), while tympana motions map to currents I(1,2)

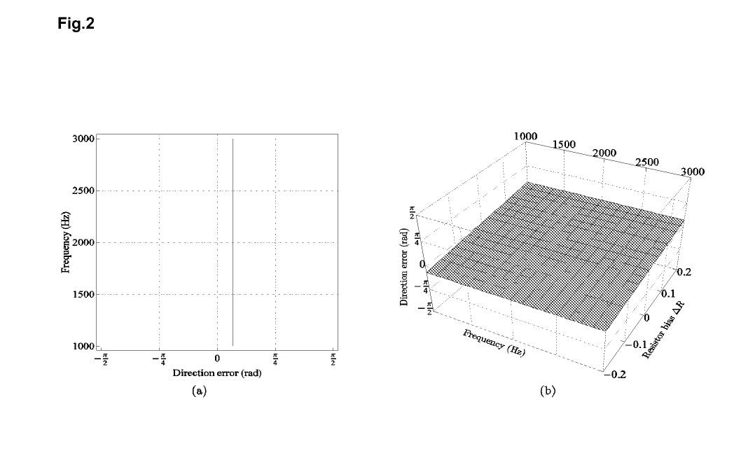

FIG. 2a shows the error when there is only a constant bias ΔR=0.2. That means R; is 20% bigger than R and R; is 20% less. The x-axis is the direction error and the y-axis is the frequency of the sound signal. The curve in the plot even does not change by frequency. That means the direction error is almost constant for different frequency signals. This is plausible, since R doesn't strongly affect the resonance frequency of the system in FIG. 1b. FIG. 2b shows the direction error against frequency f and bias ΔR. The resulting figure is a plane, showing that localization error is independent of frequency and linearly dependent on ΔR.

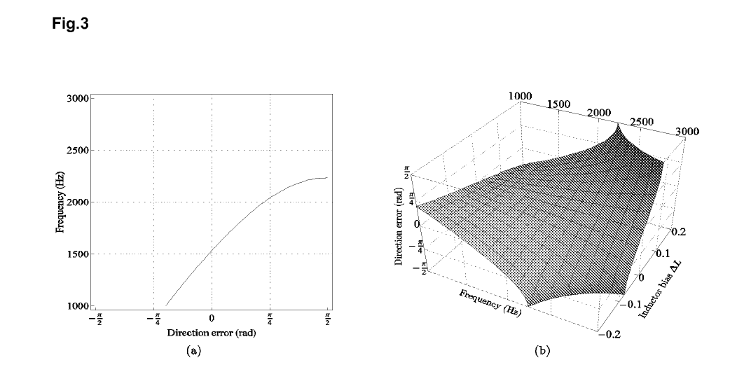

FIG. 3a shows the error when there is only a constant bias ΔL=0.2. From the curve shown in FIG. 3a, when the frequency is low, the direction error is negative. That means when the sound comes from a certain direction on the left, the model asserts that the sound comes from in front and moves straight forward. So the trajectory of the robot will be an anticlockwise spiral line. When the frequency is high, the error is positive. So the trajectory of the robot will be a clockwise spiral line. When the direction error is equal to

$$\frac{π}{2} ,$$

the trajectory of the robot will be a clockwise circle. From FIG. 3a, the curve does not exist at all frequencies. That is because when the frequency is higher, the amplitude of i₁ is always bigger than i₂, so there is no definition for θₑᵣᵣ and no solution for Eq.6. In that case, the robot will keep turning to left without going forward. So for different frequencies, the behaviour of the robot is different, though the bias is same.

FIG. 3b shows the direction error against frequency f and ΔL. The surface in FIG. 3b is more complicated. It changes by f and ΔL. From FIG. 3b, when ΔL=0, means the model is symmetrical, the direction error is always equal to 0, means no direction error and the robot could localize the sound successfully. When ΔL is positive, for low frequency signal, the direction error is negative, when the frequency goes higher, the direction error becomes positive. There is no surface (no definition for θₑᵣᵣ) near the corners of ΔL=−0.2 and ΔL=0.2 when f is high. In this case, the robot will keep turning without forward movement.

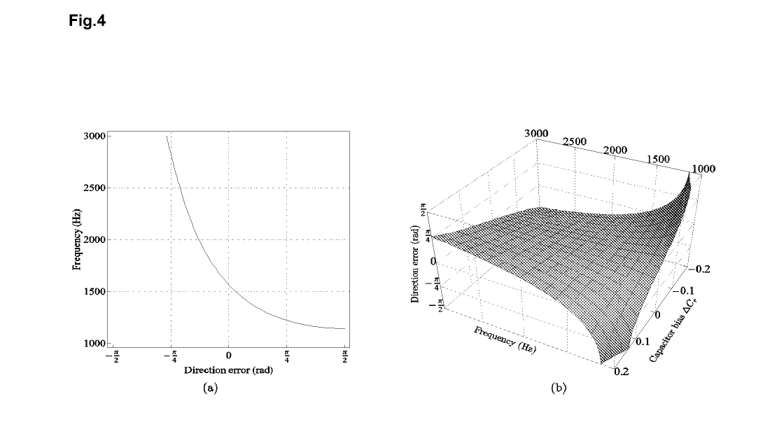

FIG. 4a shows the direction error when there is only a constant bias ΔCᵣ=−0.2 and FIG. 4b shows the direction error against frequency f and ΔCᵣ. Compare FIG. 3 and FIG. 4, the sign of the direction error is inverted and ΔL has more effect at high frequencies while ΔCᵣ has at low frequencies. For both of them, the direction error is very small around 1600 Hz, so the asymmetric model is robust to both ΔL and ΔCᵣ at this frequency.

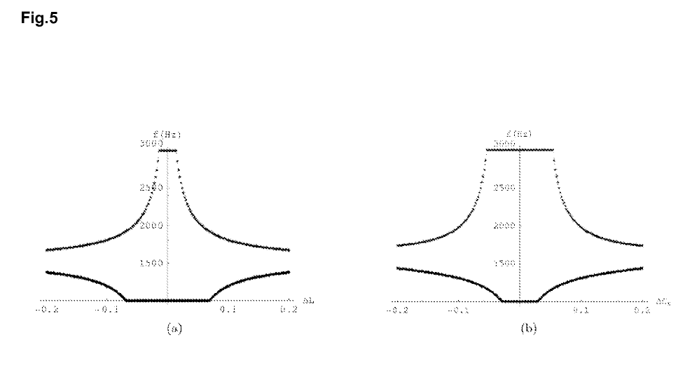

FIG. 5 shows bandwidth plotted against ΔL and ΔCᵣ. The results concentrate on single tone signals from 1000 Hz to 3000 Hz and the biases between −0.2 and 0.2. In FIG. 5, x-axis is the bias and y-axis is frequency f. The curves bound the area within which −0.2<θₑᵣᵣ<0.2, in other words, they are iso-error curves for 0.2 radians. The bandwidth for ΔL and ΔCᵣ is similar. When the bias is small, the bandwidth is wide. When the bias is big, the bandwidth is narrow. If the frequency of the signal is in this band, the robot could be sure that −0.2<θₑᵣᵣ<0.2. The constant-error bandwidth could be used to bound the direction error of the robot for different frequency signals.

### Example

In the model shown in FIG. 1b, P₁ and P₂ are used to simulate the sound pressure to the tympanums. They are represented by voltage input V₁ and V₂. The currents i₁ and i₂ are used to simulate the vibration of the tympanums. Base on the model shown in FIG. 1b,

$$\begin{matrix}\{ \begin{matrix}{i}_{1} = {G}_{11} \cdot {V}_{1} + {G}_{12} \cdot {V}_{2} \\ {i}_{2} = {G}_{21} \cdot {V}_{1} + {G}_{22} \cdot {V}_{2}\end{matrix} & ( 1 ) \\ \{ \begin{matrix}{G}_{11} = \frac{{Z}_{1} + {Z}_{3}}{{Z}_{1} {Z}_{2} + {Z}_{1} {Z}_{3} + {Z}_{2} {Z}_{3}} \\ {G}_{12} = {G}_{21} = \frac{- {Z}_{3}}{{Z}_{1} {Z}_{2} + {Z}_{1} {Z}_{3} + {Z}_{2} {Z}_{3}} \\ {G}_{22} = \frac{{Z}_{2} + {Z}_{3}}{{Z}_{1} {Z}_{2} + {Z}_{1} {Z}_{3} + {Z}_{2} {Z}_{3}}\end{matrix} & ( 2 )\end{matrix}$$

In Eq.1, G₁₁ and G₂₂ are the ipsi-lateral filters and G₁₂ and G₂₁ are the contra-lateral filters. The currents i₁ and i₂ are related to both V₁ and V₂. This is similar to the structure of the lizard ear. The model asserts that the sound comes from the louder side, means with bigger current's amplitude. If the amplitude of the two currents are identical, the model affirm that the sound comes from in front. We assume that the model is used to control a robot. So the robot will turn to the louder side. Otherwise it will go forward. In the simulation,

$$\{ \begin{matrix}{V}_{1} = sin ( ω ( t + Δ t ) ) \\ {V}_{2} = sin ( ω ( t - Δ t ) )\end{matrix} \qquad ( 3 )$$

2Δt is the time delay between the two sound signals arrived at the two ears. It relates to the direction of the sound θ.

The previous model assumes that Z₁ is same to Z₂ because normally the two ears of animals are assumed to be identical. In this case the model is symmetric. The impedance of the tympanum Z₁ and Z₂ were implemented by a resistor R, an inductor L and a capacitor Cᵣ separately. The impedance of the mouth cavity Z₃ was modelled solely by the compliance of capacitor Cᵥ. The behaviour of R is similar to the damping, dissipating energy when current pass through it. L is the inductance or the acoustical mass and produces a phase lead. Cᵣ is acoustical compliance and produces a phase lag. The eardrum impedance is a series combination of the three impedances, and the coupled eardrums are then modelled by the simple network in FIG. 1b.

$$\{ \begin{matrix}{Z}_{1} = {Z}_{2} = R + L + {C}_{r} \\ {Z}_{3} = {C}_{v}\end{matrix} \qquad ( 4 )$$

In the Eq.4, the parameters R, L, Cᵣ and Cᵥ are based on the physical parameters of the real lizard and computed by the formulas in. This model could make a good decision of the sound direction.

However, for any animal, there must be a limit to how identical the two ears can be. If Z₁≠Z₂, the model will be asymmetric and give some errors to the decision. In order to investigate the effects of asymmetry to the model, biases were added in the electric components R, L and Cᵣ.

$$\{ \begin{matrix}{R}_{1}^{′} = R \cdot ( 1 + Δ R ) & {R}_{2}^{′} = R \cdot ( 1 - Δ R ) \\ {L}_{1}^{′} = L \cdot ( 1 + Δ L ) & {L}_{2}^{′} = L \cdot ( 1 - Δ L ) \\ {C}_{r 1}^{′} = {C}_{r} \cdot ( 1 + Δ {C}_{r} ) & {C}_{r 2}^{′} = {C}_{r} ( 1 - Δ {C}_{r} )\end{matrix} \qquad ( 5 )$$

In the asymmetrical model, R′₁, L′₁ and C′ᵣ₁ are the components of Z₁ on the left side, R′₂, L′₂ and C′ᵣ₂ are for Z₂ on the right side. In this way, by adjusting the biases ΔR, ΔL and ΔCᵣ, the level of the asymmetry will be changed.

### Direction Error

When the sound comes from in front, the sound signal arrives at the two ears at the same time, the Δt in Eq.3 is 0. So V₁=V₂. If the model is symmetric, base on Eq.2 G₁₁=G₂₂. So i₁=i₂, the amplitude of them are also identical. So the robot will go forward and finally reach the sound source. However, if the model is asymmetric, G₁₁≠G₂₂ (not only the phase, but also the amplitude), the amplitude of i₁ and i₂ are not same. In that case, the robot will turn to the louder side until the amplitudes of the currents are same (if they can, see below). But at this moment, the sound does not come from in front. The direction of the sound θ at this moment is defined as the direction error θₑᵣᵣ·θₑᵣᵣ means when the model asserts that the sound comes from in front, the real direction of the sound.

From Eq.1, Eq.2 and Eq.3, the currents i₁ and i₂ are functions of the sound direction θ (Δt in V₁ and V₂) and the frequency f of the signal, if the model (the components and the biases) is given. According to the definition of direction error, θₑᵣᵣ could be solved by Eq.6¹. It is a function of the frequency of the signal θₑᵣᵣ(f).

∥i₁(f,θ)∥=∥i₂(f,θ)∥ (6)

As the biases becoming bigger, the difference between G₁₁ and G₂₂ becomes bigger to make the amplitude of one current is always bigger than the other one no matter the sound direction. In this case, the model has no pointing direction, so there is no definition of θₑᵣᵣ.

### Bandwidth for Controlled Direction Error

It is useful to know the bandwidth of the asymmetric model for controlled direction error. In this way, we could know how well does the model work for different frequency signals. The controlled direction error means that |θₑᵣᵣ(f)| is less than a constant error θ_{con}. That means although the bias will cause direction error, in this bandwidth, the error will be limited to a small value. The bandwidth could be solved by |θₑᵣᵣ(f)|<θ_{con}. For different model (the bias is different), the bandwidth is different.

1. A sound directional robot comprising:
two small, omnidirectional microphones or hydrophones, each simulating one eardrum;
an electric circuit emulating the lizard ear acoustics with sound input from the microphones, wherein the output of the circuit is fed to a model nervous system;
said model nervous system is bilateral and contains a set of band-pass filters followed by simulated El-neurons that compare inputs from the two ears by neural subtraction;
a digitally implemented signal processing platform embodying software that controls left and right-steering motors of the robot; and
a nervous system model containing a neural network that can self-adapt so as to auto-calibrate the robot.

2. The sound directional robot of claim 1, wherein said robot is provided with a head comprising binaural artificial ears (i.e. microphones and pinna-like structures).

3. The sound directional robot of claim 2, wherein it is provided with actuator means for moving the head towards an estimated position of a sound source.

4. The sound directional robot according to claim 1, wherein the artificial ears are functionally connected with computing means designed for estimating the position of a sound source based on auditory localisation cues.

5. A method for enhancing auditory localisation cues sensed via binaural artificial ears, the method comprising the step of providing an electric circuit emulating the lizard ear acoustics with sound input from two small microphones or hydrophones, wherein the output of the circuit is fed to a model nervous system, which model nervous system is bilateral and contains a set of band-pass filters followed by simulated El-neurons that compare inputs from the two ears, said model implemented on a signal processor controlling left and right-steering motors of the robot.

6. The method of claim 5, wherein the nervous system model contains a neural network that can self-adapt so as to auto-calibrate the device.

7. A sound directional sensor comprising:
two small, omnidirectional microphones or hydrophones, each simulating one eardrum;
an electric circuit emulating the lizard ear acoustics with sound input from the microphones, wherein the output of the circuit is fed to a model nervous system;
said model nervous system is bilateral and contains a set of band-pass filters followed by simulated El-neurons that compare inputs from the two ears by neural subtraction;
a digitally implemented signal processing platform embodying software that generates a directional output; and
a nervous system model containing a neural network that can self-adapt so as to auto-calibrate the sensor.

8. The sound directional sensor of claim 7, wherein said sensor is provided with a head comprising binaural artificial ears (i.e. microphones and pinna-like structures).

9. The sound directional sensor according to claim 7, wherein the artificial ears are functionally connected with computing means designed for estimating the position of a sound source based on auditory localisation cues.

10. The sound directional robot according to claim 2, wherein the artificial ears are functionally connected with computing means designed for estimating the position of a sound source based on auditory localisation cues.

11. The sound directional robot according to claim 3, wherein the artificial ears are functionally connected with computing means designed for estimating the position of a sound source based on auditory localisation cues.

12. The sound directional sensor according to claim 8, wherein the artificial ears are functionally connected with computing means designed for estimating the position of a sound source based on auditory localisation cues.
